(19) United States
(12) Patent Application Publication
(10) Pub. No.: US 2021/0312450 A1
(43) Pub. Date: Oct. 7, 2021

(54) SYSTEMS AND METHODS FOR ADVANCED VELOCITY PROFILE PREPARATION AND ANALYSIS

(71) Applicant: Mastercard International Incorporated, Purchase, NY (US)

(72) Inventors: Joshua A. Allbright, Valley Park, MO (US); Felix Johannes Flory, Wildwood, MO (US)

(21) Appl. No.: 16/837,673

(22) Filed: Apr. 1, 2020

(51) Int. Cl. G06Q 20/40; G06F 7/08; G06Q 30/02; G06N 20/00; G06N 5/04

(52) U.S. Cl. CPC G06Q 20/4016; G06F 7/08; G06N 5/04; G06N 20/00; G06Q 30/0201

(57) ABSTRACT

A system is provided. The system includes a computing device including at least one processor in communication with at least one memory device. The at least one processor is programmed to receive a plurality of data points. The at least one processor is also programmed to sort the plurality of data points into chronological order. The at least one processor is further programmed to divide the plurality of data points into a plurality of subsets. Each subset of the plurality of subsets represents a period of time. In addition, the at least one processor is programmed to process each subset to determine a velocity value for the individual subset. Moreover, the at least one processor is programmed to combine the plurality of velocity values to determine a final velocity value.

### BACKGROUND

The present application relates generally to a technology that may be used to assist in preparing and analyzing velocity profiles, and more particularly, to network-based systems and methods for using distributed processing in preparing velocity profiles for use in machine learning models.

Machine learning models rely on profiles of some variety. For example, in payment network fraud processing velocity-based profiles are commonly used. Furthermore, to improve fraud processing and message analysis, different values and dimensions for calculating those velocities are regularly experimented with. These new analyses may include profiling merchants, terminals, account ranges, entire issuers, and theoretically any combination of fields on a transaction message, derived data, or external data.

Many analysis models, especially ones built and deployed in real-time, simulate data that would exist at the point in time that the model is simulating. Many of these analysis models use real-time velocity-based inputs. The velocity-based inputs represent an amount of activity that has happened over a certain time period. However, analyzing the historical data that exists at and previous to a desired point in time may be expensive in time and processing power, especially for calculating the velocities that existed at that point in time. Accordingly, a more efficient and repeatable system for calculating velocities is desired.

### BRIEF DESCRIPTION

In one aspect, a system is provided. The system includes a computing device including at least one processor in communication with at least one memory device. The at least one processor is programmed to receive a plurality of data points. The at least one processor is also programmed to sort the plurality of data points into chronological order. The at least one processor is further programmed to divide the plurality of data points into a plurality of subsets. Each subset of the plurality of subsets represents a period of time. In addition, the at least one processor is programmed to process each subset to determine a velocity value for the individual subset. Moreover, the at least one processor is programmed to combine the plurality of velocity values to determine a final velocity value.

In another aspect, a method for analyzing a plurality of velocity values is provided. The method is implemented by a computer device including at least processor in communication with at least one memory device. The method includes receiving a plurality of data points. The method also includes sorting the plurality of data points into chronological order. The method further includes dividing the plurality of data points into a plurality of subsets. Each subset of the plurality of subsets represents a period of time. In addition, the method includes processing each subset to determine a velocity value for the individual subset. Moreover, the method includes combining the plurality of velocity values to determine a final velocity value.

In a further aspect, a computer-readable storage medium having computer-executable instructions embodied thereon is provided. When executed by a velocity analysis computing device including at least one processor in communication with a memory, the computer-readable instructions cause the velocity analysis computing device to receive a plurality of data points. The computer-readable instructions also cause the velocity analysis computing device to sort the plurality of data points into chronological order. The computer-readable instructions further cause the velocity analysis computing device to divide the plurality of data points into a plurality of subsets. Each subset of the plurality of subsets represents a period of time. In addition, the computer-readable instructions cause the velocity analysis computing device to process each subset to determine a velocity value for the individual subset. Moreover, the computer-readable instructions cause the velocity analysis computing device to combine the plurality of velocity values to determine a final velocity value.

### BRIEF DESCRIPTION OF THE DRAWINGS

FIGS. 1-6 show example embodiments of the methods and systems described herein.

FIG. 1 is a schematic diagram illustrating an example multi-party payment card system for enabling payment-by-card transactions in accordance with one embodiment of the present disclosure.

FIG. 2 is a block diagram for an example process for calculating and analyzing velocities from historical data, such as provided by the system shown in FIG. 1.

FIG. 3 is a flow diagram of an example method for calculating and analyzing velocities from historical data, such as provided by the system shown in FIG. 1.

FIG. 4 is an expanded block diagram of an example embodiment of a computer system used in calculating and analyzing velocities from historical data in accordance with one example embodiment of the present disclosure.

FIG. 5 illustrates an example configuration of a client system shown in FIG. 4.

FIG. 6 illustrates an example configuration of a server system such as the velocity analysis computing device of FIG. 4.

Although specific features of various embodiments may be shown in some drawings and not in others, this is for convenience only. Any feature of any drawing may be referenced and/or claimed in combination with any feature of any other drawing.

### DETAILED DESCRIPTION

The systems and methods described herein are directed to detecting patterns in historical data to be applied to real-time monitoring systems to detect anomalous activity in real time. In the example embodiment, a velocity analysis computing device received a plurality of data points. The velocity analysis computer device sorts the plurality of data points into chronological order. The velocity analysis computer device divides the plurality of data points into a plurality of subsets. Each subset of the plurality of subsets represents a period of time. The velocity analysis computer device processes each subset to determine a velocity value for the individual subset. The velocity analysis computer device combines the plurality of velocity values to determine a final velocity value.

To facilitate fraud and other issue detection, machine learning models are used to detect patterns of behavior and to determine the indicators that might lead to these behaviors. Furthermore, the machine learning models may analyze a multitude of different variables and parameters to determine the ideal parameters for detecting different events. However, it would be extremely expensive and inefficient to repeatedly analyze historical data for each different point in time that the models will analyze. Accordingly, the systems and methods described herein use velocity profiles to improve the speed of the machine learning models. Furthermore, the data is divided to be processed in parallel to improve the speed that the velocity profiles are generated. This allows the machine learning models to analyze a plurality of different dimensions, such as, but not limited to, card, merchant, account range, customer identifier, or point of sale country. These may be analyzed by multiple sets of data, such as from the fields of transaction messages, derived data, or external data.

The machine learning models may track the velocities of activities (i.e., the amount of activity that happens over a certain period of time). The activity could be, but is not limited to, number of transactions, sum of dollars spent, fraud score totals, or different indices based on the accounting for a merchant. However, to be able to calculate these velocity profiles, the system needs to go back through historical data and calculate velocities that would exist at every point in time that a transaction happens. If the system had a significant amount of historical data (i.e., 18 months) to analyze, it could be very expensive in time and processing power required. However, the system and method described herein significantly reduces the effort required.

Examples of situations that may be detected, include, but are not limited to, detecting a run on a bank. This may be detected by an extraordinary increase in ATM traffic. In order to detect the increase in ATM traffic, the ATM traffic needs to have been profiled over time, so that the system would know what normal ATM data is and what extremely high ATM traffic is. For example, if the normal number of ATM transactions for a day is 100 and today the number is closer to 500, then the system may flag that occurrence as out of bounds and should require further investigation. One of the advantages of the system and method described herein is to decrease the amount of time and processing power required to determine the velocities for every bank in the associated network for a year, to be able to properly model normal ATM transaction values.

The embodiments described herein leverage parallel processing to efficiently calculate velocity profiles for analysis of historical data. This enables the training of machine learning models to determine patterns of behavior. The machine learning models may use the patterns to detect anomalous activity in real-time.

To calculate velocity profiles, the velocity analysis computer device receives historical data. In the example embodiment, historical data is stored in an historical database. In some embodiments, the historical database is associated with one or more of a payment network and an issuer. In the example embodiment, the historical database includes transaction records for a plurality of payment transactions conducted over the payment processing network over a predetermined time period (e.g., over the last fifteen minutes, over the last hour, over the last six hours, over the last twenty-four hours, over the last week, over the last 28 days, etc.). For example, the transaction dataset may include all transaction records for an account range associated with a particular issuing bank over the predetermined time period. In other embodiments, the historical database includes all transactions associated with an issuer over a predetermined period of time (e.g., a year to 18 months). In still further embodiments, the historical database includes all transactions associated with a payment network over the predetermined period of time.

In the example embodiment, the historical data is filtered by the velocity analysis computer device based on one or more user inputs. For example, the user may filter the data to only include transactions associated with a specific location, merchant, issuer, payment network, and/or account number range. Next the velocity analysis computer device sorts the data based on time into chronological order.

Using the filtered and sorted data, the velocity analysis computer device divides the data into N time windows, where each time window is the same size. In some embodiments, the size of the time windows is set by the user. In other embodiments, the size of the time window is set by the velocity analysis computer device based on the model that will be using the velocity profiles. In still further embodiments, the velocity analysis computer device sets the time window based on the average number of transactions in each time window. For example, time windows may be every 15 minutes, every half an hour, every hour, every two hours, every day, etc. The transactions in every time window are grouped together with other transactions in the same time window and the group of transactions are each sent to a distributed processor, such as a client system.

The client system calculates the velocity for the transactions in the time window i that it received. In the example embodiment, the client system calculates the velocity of all of the transactions in time window i and decays the velocities to the end of the time window. In the example embodiment, the client system uses exponential decay to calculate the final velocity of each of the transactions in the time window at the end of the time window. Specifically, the decay for the last velocity value to the current time is calculated using the following Equation 1:

el_decay=x₁*e^{-(ln(2)*time_delta)} Equation 1

wherein x₁ is the previous value of the transaction whose velocity is being calculated and decayed, ln(2) the rate of decay, and time_delta is the time difference between the time of the transaction and the end of the time window. In some embodiments, the rate of decay may be scaled based on the time unit that the velocity is being built over. In these embodiments, a value of one would represent one day. For example, for a scale for a one hour velocity would use (ln(2)*(1/24)) as the decay rate. The time_delta may be expressed in terms of fractions of a day. For example, if the time between the last transaction and the current time is one second, then the time_delta would be 1/86400. The client system combines the decayed velocities for each transaction in the time window. The client system returns the final velocity value for that time window to the velocity analysis computer device. To calculate the point in time velocity for a transaction, the client system uses Equation 1 and adds it to the value of the metric on the current transaction as shown below in Equation 2.

V_{c}=vₚ*e^{-(b*w*time}^{_{delta}}⁾ Equation 2

where V_{c} is the current velocity value, x_{c} is the value of the metric of the transaction, Vₚ is the previous velocity value, b is the base rate of decay, and w is a scaling factor.

In the example embodiment, the velocity analysis computer device is in communication with a plurality of client systems. The velocity analysis computer device sends each client system one or more time windows worth of transactions to analyze in parallel. In some further embodiments, where there are more time windows than client systems, the velocity analysis computer device sends one time window to each client system. Then the velocity analysis computer device sends another time window to a client system when that client system finishes processing the previously sent time window. For example, where there are 2000 client systems and 1000 time windows, the velocity analysis computer device is able to send one time window to each of 1000 of the client systems, so that the client systems process each time window in parallel. In another example, where there are 200 client systems and 1000 time windows, the velocity analysis computer device may transmit five time windows to each client system, or the velocity analysis computer device may transmit one time window to each client system and transmits another time window to a client system, when that client system reports that it has finished processing its current time window.

The velocity analysis computer device sums the received velocities together to determine the velocities for the desired time. Then the velocity analysis computer device executes the model with the final velocities. In other embodiments, the velocity analysis computer device transmits the final velocities to a separate computer device that executes the model. In some embodiments, the velocity analysis computer device stores all of the velocities from the client systems to save time and processing power for future analysis, such as in a database. In some embodiments, the velocity analysis computer device calculates the velocity for a time window while the client systems are also processing separate time windows.

In the example embodiment, the velocity analysis computer device sums the velocities received by first decaying the velocity's values to the desired time and then summing the decayed values together.

For example, in a scenario with 100 transactions spread out over four time windows of two hours each. The velocity analysis computer device sorts the 100 transactions into chronological order. The velocity analysis computer device then divides the data into four time windows, where each time window is the same size. After division, time window A includes 15 transactions, time window B includes 25 transactions, time window C includes 40 transactions, and time window D includes 20 transactions. Each of the four time windows of transactions are transmitted to a different client system for analysis. Each client system determines the velocity of the transactions therein and decays the velocity to the end of the two hour time window. To handle the different transaction in each time window, the client system uses different values of w to calculate moving the time windows forward to the end of time window D.

The velocities for each time window are transmitted to the velocity analysis computer device. In this example, the desired time is the end of time window D. Then the velocity analysis computer device takes velocity A from time window A and decays velocity A for six hours (from the end of time window A to the end of time window D) to get velocity A′. The velocity analysis computer device also calculates velocity B′ and velocity C′. Velocity D is already at the end of its time window. These four values are then summed to determine the final velocity for the desired time.

While the above explanation uses transactions for a payment network, one having skill in the art would understand that the steps described herein may be used for any system where velocities need to be calculated for significant amounts of data over significant periods of time. For example, the systems and methods described herein may be used for analyzing sensor data, such as temperature, humidity, and vibration, for analyzing error data to detect cybersecurity threats or potential failures in devices.

The methods and system described herein may be implemented using computer programming or engineering techniques including computer software, firmware, hardware, or any combination or subset. As disclosed above, at least one technical problem with prior systems is that there is a need for systems for a cost-effective and efficient manner for generating velocity profiles for significant amounts of data. The system and methods described herein address that technical problem. Additionally, at least one of the technical solutions provided by this system to overcome technical problems may include: (i) improved speed in the analysis data points; (ii) reduced network traffic when using distributed processing resources; (iii) reduced processing required for determining velocity profiles for use in machine learning models; and (iv) ability to analyze a wide variety of parameters and dimensions.

The methods and systems described herein may be implemented using computer programming or engineering techniques including computer software, firmware, hardware, or any combination or subset thereof, wherein the technical effects may be achieved by performing at least one of the following steps: (i) receiving a plurality of data points, wherein the plurality of data points include a plurality of payment transactions; (ii) sorting the plurality of data points into chronological order; (iii) dividing the plurality of data points into a plurality of subsets, wherein each subset of the plurality of subsets represents a period of time, wherein each subset covers a different period of time and includes one or more transactions that occurred during the corresponding period of time, and wherein each subset covers the same amount of time; (iv) processing each subset to determine a velocity value for the individual subset; (v) combining the plurality of velocity values to determine a final velocity value; (vi) receiving one or more filter criteria; (vii) filtering the plurality of data points based on the one or more filter criteria; (viii) receiving, at each of a plurality of client systems, a subset including a start time and an end time; (ix) determining, by the corresponding client system, a velocity value for the received subset based on the end time; (x) determining, by the corresponding client system, the velocity value for the received subset based on decaying the velocity value of the data points in the received subset to the end time; (xi) transmitting the plurality of subsets to the plurality of client systems; (xii) receiving the plurality of velocity values from the plurality of client systems; (xiii) decaying the plurality of velocity values based on a desired point in time; (xiv) combining the plurality of decayed velocity values to determine the final velocity value; and (xv) executing a model using the final velocity value.

As will be appreciated, based on the description herein the technical improvement in velocity analysis systems as described herein is a computer-based solution to a technical deficiency or problem that is itself rooted in computer technology (e.g., the problem itself derives from the use of computer technology). More specifically, fraud and other anomalous activity is a significant problem for transactions conducted over an electronic payment network, especially for card-not-present transactions. At least some known methods and systems for detecting anomalous activity require relatively large computational resources and fail to accurately detect anomalous activity in at least some circumstances. Accordingly, to address these problems, the systems and methods described herein compute velocity scores, and analyze the computed velocity scores to identify anomalous activity.

The following detailed description of the embodiments of the disclosure refers to the accompanying drawings. The same reference numbers in different drawings may identify the same or similar elements. Also, the following detailed description does not limit the claims.

Described herein are computer systems such as velocity analysis computing devices. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “payment device,” “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), wearable computing devices, key fobs, and/or any other computing devices capable of providing account information. Moreover, these terms may refer to payments made directly from or using bank accounts, stored valued accounts, mobile wallets, etc., and accordingly are not limited to physical devices but rather refer generally to payment credentials. Each type of payment device can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to calculating and analyzing velocities.

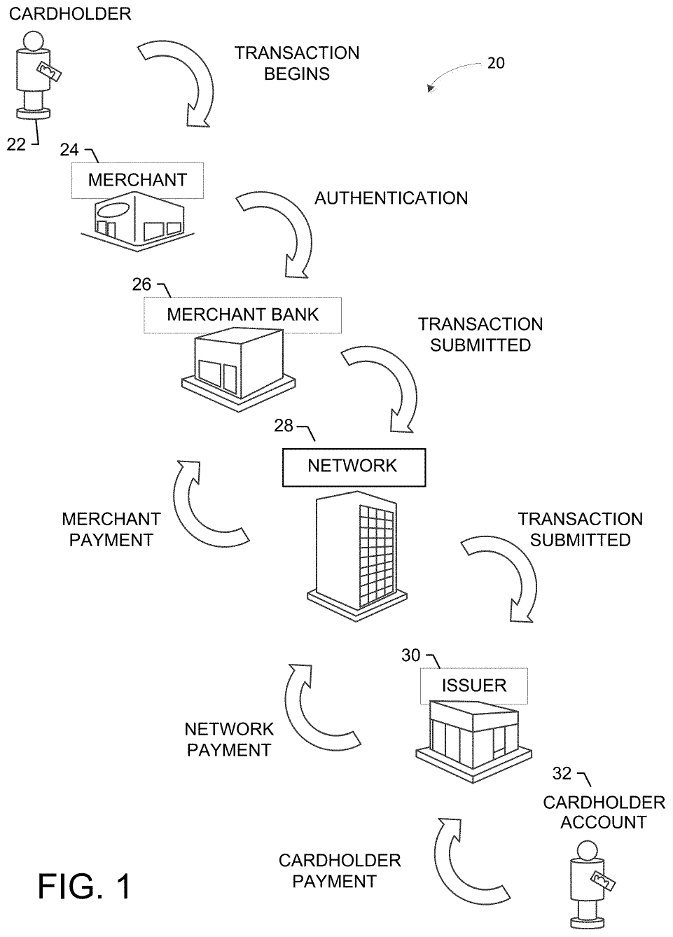

FIG. 1 is a schematic diagram illustrating an example multi-party payment card system 20 for enabling payment-by-card transactions in accordance with one embodiment of the present disclosure. FIG. 1 depicts a flow of data in a typical financial transaction through system 20.

Embodiments described herein may relate to a transaction card system, such as a credit card payment system using the Mastercard® interchange network. The Mastercard® interchange network is a set of proprietary communications standards promulgated by Mastercard International Incorporated® for the exchange of financial transaction data and the settlement of funds between financial institutions that are members of Mastercard International Incorporated®. (Mastercard is a registered trademark of Mastercard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

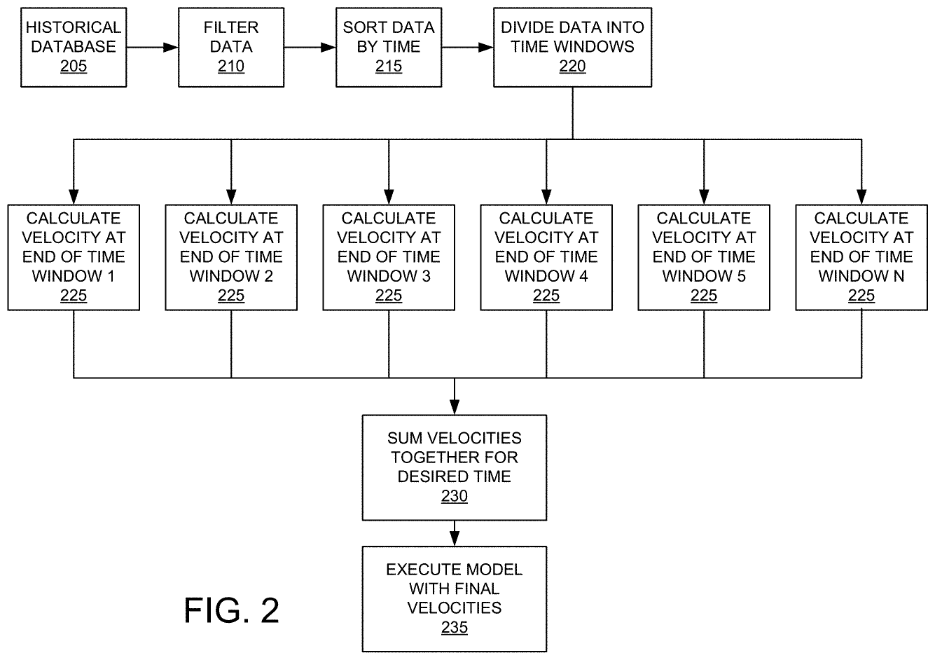

When a request for authorization is accepted, the available credit line of cardholder's 22 account 32 is decreased. Normally, a charge for a payment card transaction is not posted immediately to cardholder's 22 account 32 because bankcard associations, such as Mastercard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, transaction data including such additional transaction data may also be provided to systems including historical database 205 (shown in FIG. 2). In the example embodiment, interchange network 28 provides such transaction data (including merchant data associated with merchant tenants of each commercial real estate asset of each portfolio record) and additional transaction data. In alternative embodiments, any party may provide such data to historical database 205.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

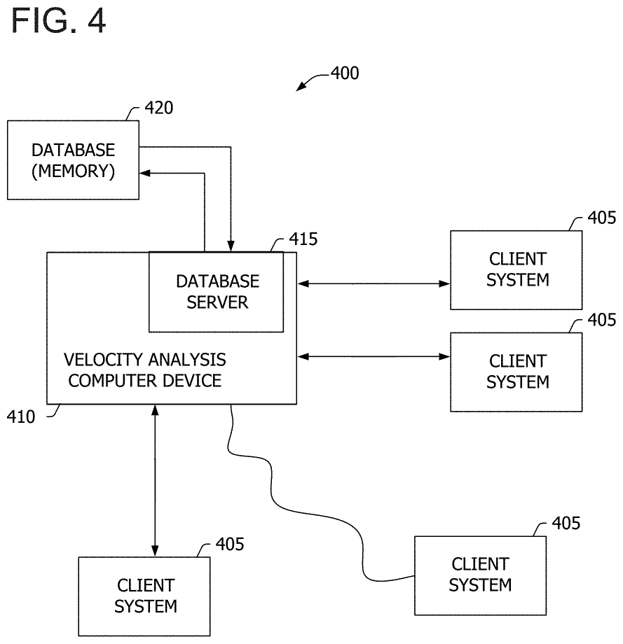

FIG. 2 is a block diagram for an example process 200 for calculating and analyzing velocities from historical data, such as provided by the system shown in FIG. 1. In the example embodiment, one or more steps of process 200 may be executed by a velocity analysis computer device 410 and one or more client systems 405 (both shown in FIG. 4). In at least one embodiment, velocity analysis computer device 410 is in communication with a plurality of client systems 405, where the client systems 405 are configured to perform parallel processing as described herein. In some further embodiments, one or more of client systems 405 and/or velocity analysis computer device 410 may be virtual computer devices, where some of all of the virtual computer devices are all hosted by the same computer device.

The embodiments described herein leverage parallel processing to efficiently calculate velocity profiles for analysis of historical data. This enables the training of machine learning models to determine patterns of behavior. The machine learning models may use the patterns to detect anomalous activity in real-time.

To calculate velocity profiles, velocity analysis computer device 410 receives historical data. In the example embodiment, historical data is stored in an historical database 205. In some embodiments, the historical database 205 is associated with one or more of a payment network 28 and an issuer 30 (both shown in FIG. 1). In some embodiments, historical database 205 is a part of velocity analysis computer device 410. In other embodiments, historical database 205 is separate from velocity analysis computer device 410. In the example embodiment, historical database 205 includes transaction records for a plurality of payment transactions conducted over the payment processing network over a predetermined time period (e.g., over the last fifteen minutes, over the last hour, over the last six hours, over the last twenty-four hours, over the last year, etc.). For example, the transaction dataset may include all transaction records for an account range associated with a particular issuing bank over the predetermined time period. In other embodiments, historical database 205 includes all transactions associated with an issuer 30 over a predetermined period of time (e.g., a year to 18 months). In still further embodiments, historical database 205 includes all transactions associated with a payment network 28 over the predetermined period of time.

In the example embodiment, the historical data is filtered 210 by the velocity analysis computer device 410 based on one or more user inputs. For example, the user may filter the data to only include transactions associated with a specific location, merchant, issuer 30, payment network 28, and/or account number range. Next the velocity analysis computer device 410 sorts 215 the data based on time into chronological order.

Using the filtered and sorted data, the velocity analysis computer device 410 divides 220 the data into N time windows, where each time window is the same size. In some embodiments, the size of the time windows is set by the user. In other embodiments, the size of the time window is set by the velocity analysis computer device 410 based on the model that will be using the velocity profiles. In still further embodiments, the velocity analysis computer device 410 sets the time window based on the average number of transactions in each time window. For example, time windows may be every 15 minutes, every half an hour, every hour, every two hours, every day, etc. The transactions in every time window are grouped together with other transactions in the same time window and the group of transactions are each sent to a distributed processor, such as client system 405. To handle the different transaction in each time window, the client system 405 uses different values of w to calculate moving the time windows A-C forward to the end of time window D.

The client system 405 calculates 225 the velocity for the transactions in the time window i that it received. In the example embodiment, the client system 405 calculates 225 the velocity of all of the transactions in time window i and decays the velocities to the end of the time window. In the example embodiment, the client system 405 uses exponential decay to calculate the final velocity of each of the transactions in the time window at the end of the time window. Specifically, the decay for the last velocity value to the current time is calculated using the following Equation 1:

el_decay=x₁*e^{-(ln(2)*time_delta)} Equation 1

wherein x₁ is the previous value of the transaction whose velocity is being calculated and decayed, ln(2) the rate of decay, and time_delta is the time difference between the time of the transaction and the end of the time window. In some embodiments, the rate of decay may be scaled based on the time unit that the velocity is being built over. In these embodiments, a value of one would represent one day. For example, for a scale for a one hour velocity would use (ln(2)*( 1/24)) as the decay rate. The time_delta may be expressed in terms of fractions of a day. For example, if the time between the last transaction and the current time is one second, then the time_delta would be 1/86400. The client system 405 combines the decayed velocities for each transaction in the time window. The client system 405 returns the final velocity value for that time window to the velocity analysis computer device. To calculate the point in time velocity for a transaction, the client system 405 uses Equation 1 and adds it to the value of the metric on the current transaction as shown below in Equation 2.

V_{c}=vₚ*e^{-(b*w*time}^{_{delta}}⁾ Equation 2

where V_{c} is the current velocity value, x_{c} is the value of the metric of the transaction, Vₚ is the previous velocity value, b is the base rate of decay, and w is a scaling factor.

In the example embodiment, the velocity analysis computer device 410 is in communication with a plurality of client systems 405. The velocity analysis computer device 410 sends each client system 405 one or more time windows worth of transactions to analyze in parallel. In some further embodiments, where there are more time windows than client systems 405, the velocity analysis computer device 410 sends one time window to each client system 405. Then the velocity analysis computer device 410 sends another time window to a client system 405 when that client system 405 finishes processing the previously sent time window. For example, where there are 2000 client systems 405 and 1000 time windows, the velocity analysis computer device 410 is able to send one time window to each of 1000 of the client systems 405, so that the client systems 405 process each time window in parallel. In another example, where there are 200 client systems 405 and 1000 time windows, the velocity analysis computer device 410 may transmit five time windows to each client system 405, or the velocity analysis computer device 410 may transmit one time window to each client system 405 and transmits another time window to a client system 405, when that client system 405 reports that it has finished processing its current time window.

The velocity analysis computer device 410 sums 230 the received velocities together to determine the velocities for the desired time. Then the velocity analysis computer device 410 executes 235 the model with the final velocities. In other embodiments, the velocity analysis computer device 410 transmits the final velocities to a separate computer device that executes the model. In some embodiments, the velocity analysis computer device 410 stores all of the velocities from the client systems 405 to save time and processing power for future analysis, such as in database 420 (shown in FIG. 4). In some embodiments, the velocity analysis computer device 410 calculates 225 the velocity for a time window while the client systems 405 are also processing separate time windows.

In the example embodiment, the velocity analysis computer device 410 sums 230 the velocities received by first decaying the velocity's values to the desired time and then summing the decayed values together.

For example, in a scenario with 100 transactions spread out over four time windows of two hours each. The velocity analysis computer device 410 sorts 215 the 100 transactions into chronological order. The velocity analysis computer device 410 then divides 220 the data into four time windows, where each time window is the same size. After division, time window A includes 15 transactions, time window B includes 25 transactions, time window C includes 40 transactions, and time window D includes 20 transactions. Each of the four time windows of transactions are transmitted to a different client system 405 for analysis. Each client system 405 determines the velocity of the transactions therein and decays the velocity to the end of the two hour time window. To handle the different transaction in each time window, the client system 405 uses different values of w to calculate moving the time windows forward to the end of time window D.

The velocities for each time window are transmitted to the velocity analysis computer device 410. In this example, the desired time is the end of time window D. Then the velocity analysis computer device 410 takes velocity A from time window A and decays velocity A for six hours (from the end of time window A to the end of time window D) to get velocity A′. The velocity analysis computer device 410 also calculates velocity B′ and velocity C′. Velocity D is already at the end of its time window. These four values are then summed 230 to determine the final velocity for the desired time.

While the above explanation uses transactions for a payment network, one having skill in the art would understand that the steps described herein may be used for any system where velocities need to be calculated for significant amounts of data over significant periods of time.

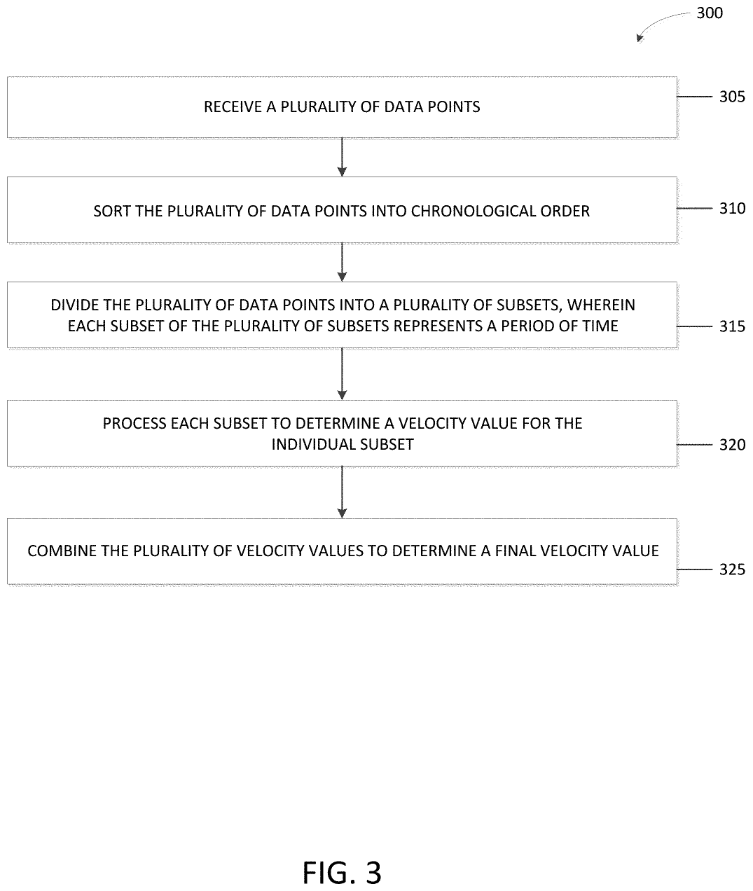

FIG. 3 is a flow diagram of an example method 300 for calculating and analyzing velocities from historical data, such as provided by the system (shown in FIG. 1). In the example embodiment, method 300 is performed by the velocity analysis computer device 410 (shown in FIG. 4).

In the example embodiment, the velocity analysis computer device 410 receives 305 a plurality of data points. The plurality of data points are each associate with a point in time. In some embodiments, the plurality of data points includes a plurality of payment transactions. In some embodiments, the velocity analysis computer device 410 receives 305 the plurality of data points from the historical database 205 (shown in FIG. 2). The velocity analysis computer device 410 sorts 310 the plurality of data points into chronological order. In some embodiments, the velocity analysis computer device 410 receives one or more filter criteria, such as from a user. The velocity analysis computer device 410 filters the plurality of data points based on the one or more filter criteria prior to the chronological sorting 310.

In the example embodiment, the velocity analysis computer device 410 divides 315 the plurality of data points into a plurality of subsets. Each subset of the plurality of subsets represents a period of time. Each subset covers a different period of time and includes one or more transactions that occurred during the corresponding period of time. Each subset also covers the same amount of time. For example, the subsets could each represent one hour in a 24 hour day.

In the example embodiment, the velocity analysis computer device 410 processes 320 each subset to determine a velocity value for the individual subset. The velocity analysis computer device 410 transmits the plurality of subsets to a plurality of client systems 405 (shown in FIG. 4). Each client system 405 is programmed to receive a subset including a start time and an end time. The client systems 405 also programmed to determine a velocity value for the received subset based on the end time. In some embodiments, the client systems 405 are programmed to determine the velocity value for the received subset based on decaying the velocity value of the data points in the received subset to the end time. The client systems 405 are further programmed to transmit the decayed velocity value for its subset to the velocity analysis computer device 410.

In the example embodiment, the velocity analysis computer device 410 combines 325 the plurality of velocity values to determine a final velocity value. In some embodiments, the velocity analysis computer device 410 decays the plurality of velocity values based on a desired point in time. The velocity computer device 410 combines the plurality of decayed velocity values to determine the final velocity value. In some further embodiments, the velocity analysis computer device 410 executes a model using the final velocity value.

FIG. 4 is an expanded block diagram of an example embodiment of a computer system 400 used in calculating and analyzing velocities from historical data in accordance with one example embodiment of the present disclosure. In the example embodiment, system 400 is used for calculating velocities from historical transaction data, as described herein.

More specifically, in the example embodiment, system 400 includes velocity analysis computer device 410, and a plurality of client sub-systems, also referred to as client systems 405, connected to velocity analysis computer device 410. In one embodiment, client systems 405 are computers including a web browser, such that velocity analysis computer device 410 is accessible to client systems 405 using the Internet and/or using a network (not shown). Client systems 405 are interconnected to the Internet through many interfaces including a network, such as a local area network (LAN) or a wide area network (WAN), dial-in-connections, cable modems, special high-speed Integrated Services Digital Network (ISDN) lines, and RDT networks. Client systems 405 may include systems associated with cardholders 22 (shown in FIG. 11) as well as external systems used to store data. In some embodiments, velocity analysis computer device 410 is also in communication with payment network 28. Client systems 405 could be any device capable of interconnecting to the Internet including, but not limited to, a desktop computer, a laptop computer, a personal digital assistant (PDA), a cellular phone, a smartphone, a tablet, a phablet, or other web-based connectable equipment.

A database server 415 is connected to database 420, which contains information on a variety of matters, such as vectors for different time windows and historical data, as described above in greater detail. In one embodiment, centralized database 420 is stored on velocity analysis computer device 410 and can be accessed by potential users at one of client systems 405 by logging onto velocity analysis computer device 410 through one of client systems 405. In an alternative embodiment, database 420 is stored remotely from velocity analysis computer device 410 and may be non-centralized. Database 420 may be a database configured to store information used by velocity analysis computer device 410 including, for example, transaction records, as described herein. In at least one embodiment, database 420 is similar to or includes historical database 205 (shown in FIG. 2).

Database 420 may include a single database having separated sections or partitions, or may include multiple databases, each being separate from each other. Database 420 may store transaction data generated over the processing network including data relating to merchants, consumers, account holders, prospective customers, issuers, acquirers, and/or purchases made. Database 420 may also store account data including at least one of a cardholder name, a cardholder address, an account number, other account identifiers, and transaction information. Database 420 may also store merchant information including a merchant identifier that identifies each merchant registered to use the network, and instructions for settling transactions including merchant bank account information. Database 420 may also store purchase data associated with items being purchased by a cardholder from a merchant, and authorization request data.

In the example embodiment, one of client systems 405 may be associated with one of acquirer bank 26 (shown in FIG. 1) and issuer bank 30 (also shown in FIG. 1). For example, one of client systems 405 may be a POS device. Client systems 405 may additionally or alternatively be associated with a user (e.g., a commercial real estate owner or lender, a marketing director, a consumer, or any other end user). In the example embodiment, one of client systems 405 includes a user interface (not shown). For example, the user interface may include a graphical user interface with interactive functionality, such that modeling results, transmitted from velocity analysis computer device 410 to client system 405, may be shown in a graphical format. A user of client system 405 may interact with the user interface to view, explore, and otherwise interact with the message tracking results. A user may also operate the user interface to define a date and/or attributes analysis, as described herein. Velocity analysis computer device 410 may be associated with interchange network 28 and/or may process transaction data.

In some further embodiments, client systems 405 may be used for calculating velocities at the end of a time window. In these embodiments, the client system 405 may receive data for a time window and calculate the velocity (or velocities) desired at the end of that time window. In the example embodiment, multiple client systems 405 may be used to calculate velocities for multiple time windows in parallel. These calculations may be performed simultaneously or nearly simultaneously.

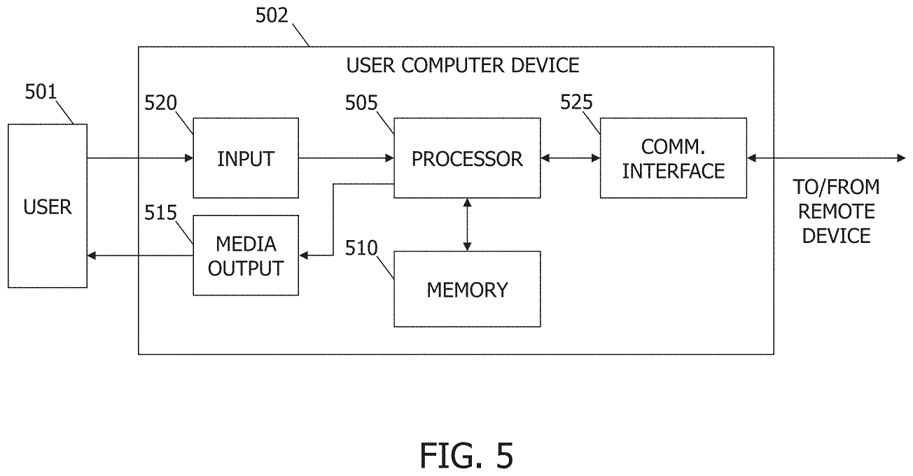

FIG. 5 illustrates an example configuration of a client computing device 502. Client computing device 502 may include, but is not limited to, client systems (“client computing devices”) 405 (shown in FIG. 4). Client computing device 502 includes a processor 505 for executing instructions. In some embodiments, executable instructions are stored in a memory area 510. Processor 505 may include one or more processing units (e.g., in a multi-core configuration). Memory area 510 is any device allowing information such as executable instructions and/or other data to be stored and retrieved. Memory area 510 may include one or more computer-readable media.

Client computing device 502 also includes at least one media output component 515 for presenting information to a user 501. Media output component 515 is any component capable of conveying information to user 501. In some embodiments, media output component 515 includes an output adapter such as a video adapter and/or an audio adapter. An output adapter is operatively coupled to processor 505 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 502 includes an input device 520 for receiving input from user 501. Input device 520 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 515 and input device 520.

Client computing device 502 may also include a communication interface 525, which is communicatively couplable to a remote device such as velocity analysis computer device 410 (shown in FIG. 4). Communication interface 525 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 510 are, for example, computer-readable instructions for providing a user interface to user 501 via media output component 515 and, optionally, receiving and processing input from input device 520. A user interface may include, among other possibilities, a web browser and client application. Web browsers enable users 501 to display and interact with media and other information typically embedded on a web page or a website from a web server associated with a merchant. A client application allows users 501 to interact with a server application associated with, for example, a merchant. The user interface, via one or both of a web browser and a client application, facilitates display of message tracking results by velocity analysis computer device 410.

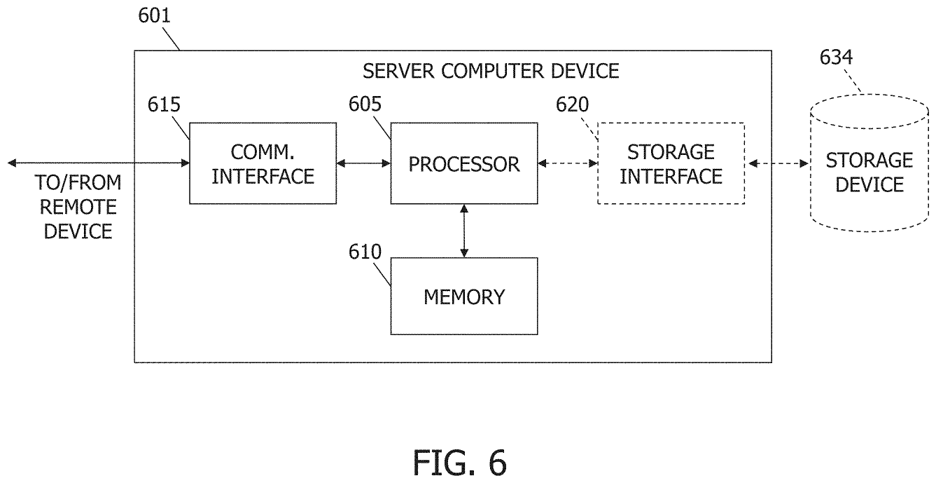

FIG. 6 illustrates an example configuration of a server system 601 such as velocity analysis computer device 410 (shown in FIG. 4), in accordance with one example embodiment of the present disclosure. Server system 601 may also include, but is not limited to, database server 415 and velocity analysis computer device 410 (both shown in FIG. 4). In the example embodiment, server system 601 computes and analyzes velocity profiles based on historical data, as described below.

Server system 601 includes a processor 605 for executing instructions. Instructions may be stored in a memory area 610, for example. Processor 605 may include one or more processing units (e.g., in a multi-core configuration) for executing instructions. The instructions may be executed within a variety of different operating systems on the server system 601, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 605 is operatively coupled to a communication interface 615 such that server system 601 is capable of communicating with a remote device such as a user system or another server system 601. For example, communication interface 615 may receive requests from a client system 405 via the Internet, as illustrated in FIG. 4.

Processor 605 may also be operatively coupled to a storage device 634. Storage device 634 is any computer-operated hardware suitable for storing and/or retrieving data. In some embodiments, storage device 634 is integrated in server system 601. For example, server system 601 may include one or more hard disk drives as storage device 634. In other embodiments, storage device 634 is external to server system 601 and may be accessed by a plurality of server systems 601. For example, storage device 634 may include multiple storage units such as hard disks or solid state disks in a redundant array of inexpensive disks (RAID) configuration. Storage device 634 may include a storage area network (SAN) and/or a network attached storage (NAS) system.

In some embodiments, processor 605 is operatively coupled to storage device 634 via a storage interface 620. Storage interface 620 is any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 634.

Memory area 610 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

The processor 605 executes computer-executable instructions for implementing aspects of the disclosure. In some embodiments, the processor 605 is transformed into a special purpose microprocessor by executing computer-executable instructions or by otherwise being programmed. For example, the processor 605 is programmed with instructions shown in FIGS. 2 and 3.

A processor or a processing element in the embodiments described herein may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image data, text data, report data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, the computer network hosting the computer device, services executing on the computer device, and/or other data.

Based upon these analyses, the processing element may learn how to identify characteristics and patterns that may then be applied to training models, analyzing transaction and authentication data, and detecting and analyzing risk.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
a computing device comprising at least one processor in communication with at least one memory device, wherein the at least one processor is programmed to:
receive a plurality of data points;
sort the plurality of data points into chronological order;
divide the plurality of data points into a plurality of subsets, wherein each subset of the plurality of subsets represents a period of time;
process each subset to determine a velocity value for the individual subset; and
combine the plurality of velocity values to determine a final velocity value.

2. The system of claim 1, wherein the at least one processor is further programmed to:
receive one or more filter criteria; and
filter the plurality of data points based on the one or more filter criteria.

3. The system of claim 1, wherein the plurality of data points include a plurality of payment transactions.

4. The system of claim 1, wherein each subset covers a different period of time and includes one or more transactions that occurred during the corresponding period of time.

5. The system of claim 4, wherein each subset covers the same amount of time.

6. The system of claim 1, further comprising a plurality of client systems, wherein each client system of the plurality of clients systems is programmed to:
receive a subset including a start time and an end time; and
determine a velocity value for the received subset based on the end time.

7. The system of claim 6, wherein each of the client systems is further programmed to determine the velocity value for the received subset based on decaying the velocity value of the data points in the received subset to the end time.

8. The system of claim 6, wherein the at least one processor is further programmed to:
transmit the plurality of subsets to the plurality of client systems; and
receive the plurality of velocity values from the plurality of client systems.

9. The system of claim 1, wherein the at least one processor is further programmed to:
decay the plurality of velocity values based on a desired point in time; and
combine the plurality of decayed velocity values to determine the final velocity value.

10. The system of claim 1, wherein the at least one processor is further programmed to execute a model using the final velocity value.

11. A method for analyzing a plurality of velocity values, the method implemented by a computer device comprising at least processor in communication with at least one memory device, the method comprising:
receiving a plurality of data points;
sorting the plurality of data points into chronological order;
dividing the plurality of data points into a plurality of subsets, wherein each subset of the plurality of subsets represents a period of time;
processing each subset to determine a velocity value for the individual subset; and
combining the plurality of velocity values to determine a final velocity value.

12. The method of claim 11 further comprising:
receiving one or more filter criteria; and
filtering the plurality of data points based on the one or more filter criteria.

13. The method of claim 11, wherein the plurality of data points include a plurality of payment transactions.

14. The method of claim 11, wherein each subset covers a different period of time and includes one or more transactions that occurred during the corresponding period of time, and wherein each subset covers the same amount of time.

15. The method of claim 11 further comprising:
receiving, at each of a plurality of client systems, a subset including a start time and an end time; and
determining, by the corresponding client system, a velocity value for the received subset based on the end time.

16. The method of claim 15 further comprising determining, by the corresponding client system, the velocity value for the received subset based on decaying the velocity value of the data points in the received subset to the end time.

17. The method of claim 15 further comprising:
transmitting the plurality of subsets to the plurality of client systems; and
receiving the plurality of velocity values from the plurality of client systems.

18. The method of claim 11 further comprising:
decaying the plurality of velocity values based on a desired point in time; and
combining the plurality of decayed velocity values to determine the final velocity value.

19. The method of claim 11 further comprising executing a model using the final velocity value.

20. A computer-readable storage medium having computer-executable instructions embodied thereon, wherein when executed by a velocity analysis computing device including at least one processor in communication with a memory, the computer-readable instructions cause the velocity analysis computing device to:
receive a plurality of data points;
sort the plurality of data points into chronological order;
divide the plurality of data points into a plurality of subsets, wherein each subset of the plurality of subsets represents a period of time;
process each subset to determine a velocity value for the individual subset; and
combine the plurality of velocity values to determine a final velocity value.
